(19) United States
(12) Patent Application Publication
(10) Pub. No.: US 2004/0034798 A1
(43) Pub. Date: Feb. 19, 2004

(54) Network system

(76) Inventors: Yuka Yamada, Nara (JP); Nobuyasu Suzuki, Nara (JP); Takehito Yoshida, Tokushima (JP); Toshiharu Makino, Hyogo (JP)

Correspondence Address: RATNERPRESTIA, P O BOX 980, VALLEY FORGE, PA, 19482-0980, US

(21) Appl. No.: 10/600,972

(22) Filed: Jun. 20, 2003

(30) Foreign Application Priority Data
Jun. 26, 2002 (JP) 2002-185763

(51) Int. Cl. G06F 11/30

(52) U.S. Cl. 713/201

(57) ABSTRACT

A provider architects an environment for connection to the Internet, to architect a network security system over a home server and Web terminal connected to the Internet. The network security system has a firewall and anti-virus software. The provider bills the initial fee in return for architecting the network security system. Furthermore, it makes a regular billing in return for providing such a service as regularly updating the system.

### FIELD OF THE INVENTION

This invention relates to a network system utilizing the Internet and, more particularly, to a network system that the provider, for proxy, carries out a troublesome operation related to network security to thereby provide a secure and comfort Internet connecting environment reduced in the labor and risk of the individual.

### BACKGROUND OF THE INVENTION

Recently, concurrently with the spread of comparatively cheap best-effort around-the-clock connection type of service such as xDSL (x digital subscriber line), it becomes general practice for the usual household including a home office to have an around-the-clock connection to the Internet. Due to this, the failure by a computer virus which is a program to intrude into and damage the Web terminal, outspreads down to the household Web terminal. Besides failures by such viruses as to arise infection and disease upon executing the file attached to an e-mail, there is an outspread of the failure to the household by a virus called a worm, that the program itself gets a direct access to the Web terminal through the Internet and sneaks through a security hole of operating system or the like, thereby making a spread of infection and failure.

Meanwhile, in the around-the-clock connection environment, there is an increasing possibility to allow an unauthorized access to a Web terminal via the network. This increases risk that the Web terminal be intruded by a hacker, resulting in damage to or steal of the data.

However, the conventional personal service by an Internet provider places an emphasis upon providing an environment for connection to the Internet. It is the present situation that connecting operation, environmental architecture and network security are relied mostly upon the skill and knowledge of the individual user.

In the foregoing situation, the person making a connection to the Internet does not necessarily possess the skill and knowledge about security or the like. Thus, there are an acceleratedly increasing number of Web terminals carelessly placed in always connection to the Internet, possibly leading to huge causality.

Furthermore, so-called the Web home electric system, to connect household electric appliances such as an electronic oven and refrigerator, rises in the market. There is a concern over the spreading failure of computer virus to such Web home electric appliances. On the other hand, the home security system, for household or store crime/disaster prevention, is now brought under operation through the utilization of the Internet. There is an increasing risk that the home security system set up in the usual household or store be corrupted by a computer virus or invaded by a hacker.

### SUMMARY OF THE INVENTION

The present invention has been made in view of the foregoing problem, and it is an object thereof for a business entity such as a provider, as a proxy for a user, to provide a secure and comfort Internet connecting environment reduced in individual's labor and risk through architecting, maintaining and obtaining/sending information from/to a network security system for an Internet environment.

A network system of the invention allows for a provider to architect a connection environment to the Internet and a security system over a Web terminal connected to the Internet. Meanwhile, optional services are provided for a user to receive security information. The provider makes a bill in return for architecting a security system and user's utilizing an optional service to receive security service.

According to the above configuration, it is possible to provide a safe and comfort Internet connecting environment reduced in individual's labor and risk.

### BRIEF DESCRIPTION OF THE DRAWINGS

FIG. 1 is a concept diagram showing the overall configuration of a personal network security system according to embodiment 1 of the invention;

FIG. 2 is a flowchart explaining the utilization step of the personal network security system according to embodiment 2 of the invention; and

FIG. 3 is a block diagram explaining the concept of a data update service to the personal network security system according to embodiment 2 of the invention.

### DESCRIPTION OF THE PREFERRED EMBODIMENT

Exemplary embodiments of the present invention are demonstrated hereinafter with reference to the accompanying drawings.

1. First Exemplary Embodiment

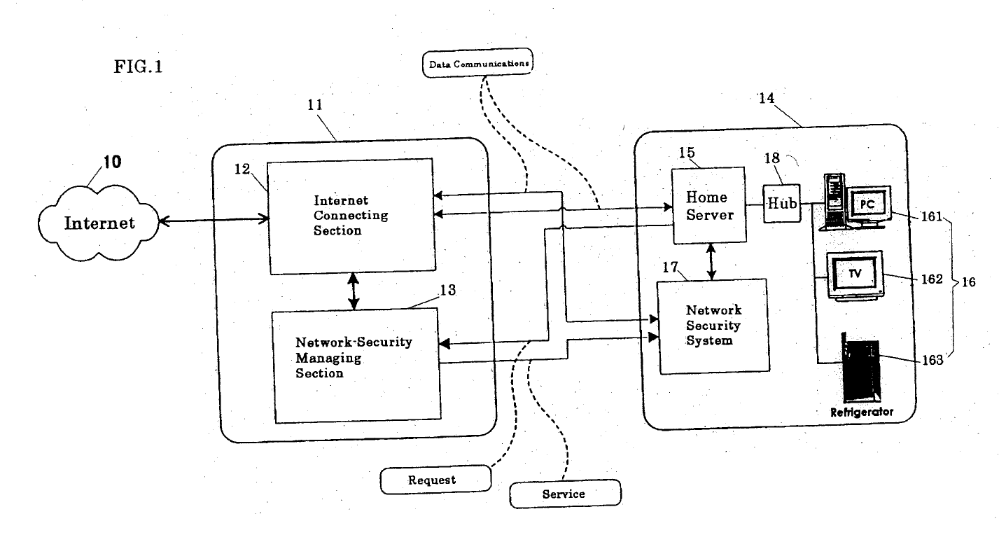

FIG. 1 is a concept diagram showing the overall configuration of a personal network security system in embodiment 1 of the present invention. In FIG. 1, a provider 11 has an Internet connecting section 12 for connecting a user's home server 15 and Web terminal 16 to the Internet 10 and a network-security managing section 13. A household network system 14 has a home server 15, a plurality of Web terminals 16, and a network security system 17 for the home server 15. The output of the home server 15 is branched by a hub 16 and connected to the Web terminals 16.

The home server 15 uses a personal computer, a digital TV receiver or the like. The Web terminal 16 uses, besides a personal computer 161, a TV receiver 162 and so-called a Web home electric appliance 163, e.g. an electronic oven or a refrigerator, connected to the network.

The provider 11 architects, as an Internet-connecting basic service, a connection environment to the Internet 10 over the home server 15 of the home network system 14, by the Internet connecting section 12. In this stage, the usual connection service by the provider is completed, i.e. the user usually connects by himself the Web terminal 16 and the home server 15. Incidentally, a certain provider, for proxy, possibly connects between the home server 15 and the Web terminal 16, for pay.

Then, a network security system 17 is architected over the home server 15. Specifically, a firewall is architected on hardware or software. Furthermore, the hardware or software for filtering, routing and the like is introduced in accordance with the purpose and need of the user. In addition, anti-virus software is introduced in the service. In the case that the network security system 17 is configured on hardware, the relevant hardware is connected to between the Internet connecting section 12 of the provider 11 and the home server 15. Where the network security system 17 is configured on software, the relevant software is installed from the network-security managing section 13 of the provider 11 to the home server 15.

The network security system 17 resides over the home server 15. When the home server 15 is put into operation, the network security system 17 starts up at least before connection to the Internet connection section 11, to monitor a security state of connection to the Internet connecting section 11. Accordingly, the home server 15 and the Web terminal 16 in connection with the home server 15 can previously prevent a virus intrusion or unauthorized access through the Internet connecting section 11.

The provider 11 makes a bill of a contraction fee and monthly connect rate, in return for architecting the connection environment of the Internet connecting section 12 and home server 15 to the Internet 10. It also makes a bill of a contraction fee and monthly connect rate in return for the architecture of the network security system 17.

Incidentally, where the Web terminal 16 is one in the number, the home server 15 and the hub 18 may be omitted. Otherwise, by omitting the home server 15, the Internet connection section may be directly connected to the hub 18 so that the network security system 17 can be connected or installed to each of the Web terminals 16.

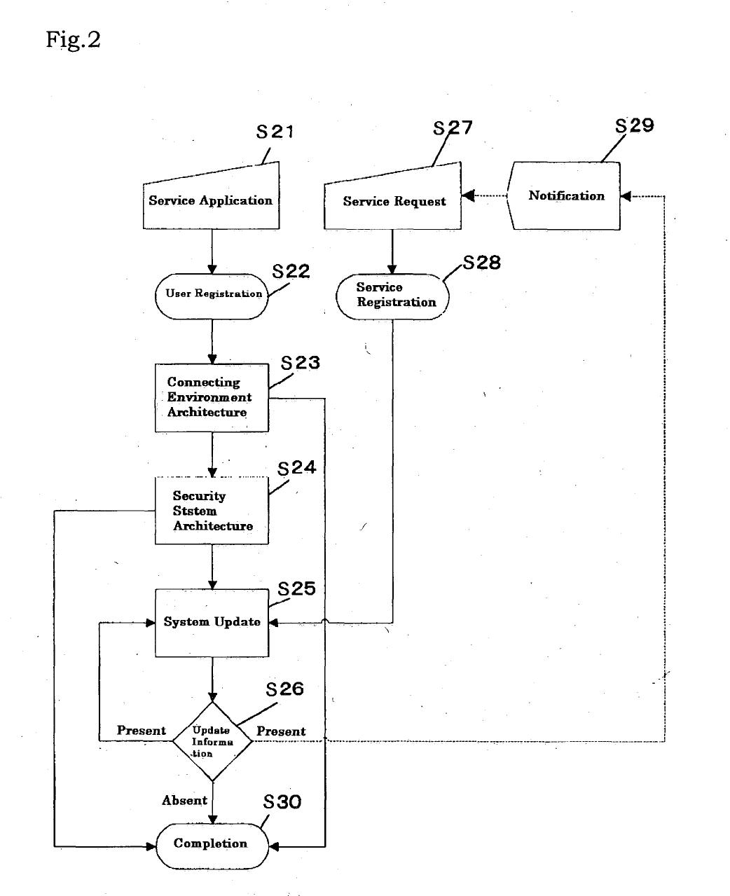

FIG. 2 is a flowchart explaining a use step of the personal network security system of FIG. 1. In step S21, a user of the home network 14 makes an application for using the Internet and security service to the provider 11. The provider 11 in step S22 makes a user registration with the network-security managing section 13 and, in step S23, architects a connection environment of between the Internet connecting section 12 and the home server 15. In the case that Internet connection is through utilizing a telephone line, the connection environment is architected by software installation. Where through a private broadband line such as a CATV line or optical cable, a cable modem, a network adapter and the like are provided by installation work. After the connection environment have been architected, connection is provided between the Internet connection section 12 and the home server 15. The home server 15 is thus allowed for connection to the Internet 10.

Next, in step S24, the network security system 17 is then architected. The network security system 17 is for introducing a firewall as a measure against an unauthorized access, and anti-virus software, wherein architecture is performed by either one or both of hardware and software. In the case to configure a network security system 17 on hardware, the hardware is installed by an engineer of provider 11 at a user's house of the home network 14. Setting is provided to connect the internet connecting section 12 of the provider 11 to the home server 15 through the network security system 17. In the case to configure a network security system 17 on software, the home server 15 sends a request 19 to the network-security managing section 13 of the provider 11. In response to the request 19, the network-security managing section 13 sends the software 20 to the network-security system 17 and installs it thereon. When to configure a network security system 17 on both hardware and software, the both, i.e. setting up hardware at the house of the user and installing software 20 from the network-security managing section 13 are done. Incidentally, filtering, routing and the like are also introduced, as required, in accordance with the purpose and need of the user of the home network 14.

In the case the application for using the Internet and security service in step S21 is for architecting a connection environment and initially set a network security system, the setting ends in the step S24 thus completing the proceeding in the step S30. After completing the proceeding, the network-security managing section 13 manages the contraction fee at the initial setting and monthly connect rate, to bill it to the user.

2. Second Exemplary Embodiment

In the meanwhile, new species of computer viruses come into emerging day by day. In order to cope, therewith, virus vaccine must be updated to those.

Meanwhile, the network attacking way by a malicious third party becomes trickier. There is a need to update the content of a firewall in a corresponding manner. Embodiment 2 provides personal a network security system that can cope with the problem.

In embodiment 2, the network-security managing section 13 of provider 11 in the FIG. 1 is to update a virus vaccine correspondingly to a new species of computer virus and to further update the firewall content. The update information is provided as a network security update service by the network-security managing system 13 regularly or each time of updating, to the network-security system 17 architected by an Internet connection service.

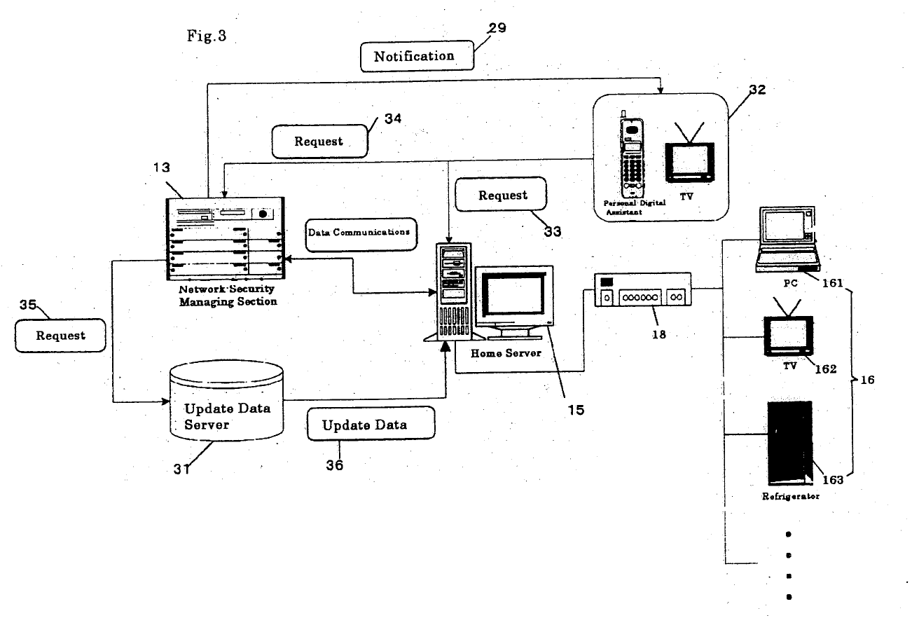

FIG. 3 is a block diagram explaining the concept of a data update by the network-security managing section 13 and a data update service to the network-security system 17, in embodiment 2 of the invention. The concept of data update service will be explained, with reference also to the flowchart of FIG. 2.

The network-security managing section 13, in step 25, always monitors an environmental change of computer virus and an emergence of new species/subspecies thereof. When it is determined in step S26 that there is update information about an environmental change or emergence of a new species/subspecies of virus, the process returns to step S25 where the data thereof is stored to an update data server 31 thereby updating a vaccine. Meanwhile, when it is determined in the step S26 that there is caused a new security hole such as a new kind of network attack means, in the step S25 the data thereof is similarly stored to the update data server 31 thereby updating the firewall.

In case the user of the home network 14 in step S27 makes a request 33, 34 for a data update service to security service from the home server 15, personal digital assistant 32 or the like to the provider 11, the network-security managing section 13 in step S28 makes a service registration and, in step S25, proceeds to a system update step to the network security system 17. As noted before, the network-security managing section 13 always monitors a computer virus and security-hole update information. In the case there is update information in step S26, the process returns to step S25 where a request for sending update data 35 is sent to the update server 31. In response to the request, the update server 31 sends update data 36 to the home server 15 to thereby provide a service and update the network security system 17. In the absence of update information, system update for data-adding is not carried out.

In the case the user of the home network 14 has not made a service request in step S27, when there is update information of computer virus and security hole, in case there is update information in step S26 in the system update to another user making a service request, the network-security managing section 13 in step S29 makes a notification 29 on the presence of update information to the home server 15 or personal digital assistant 32 of the user having not made a service request, thereby prompting to make a service request.

The request for data update information providing service in the step S27 is provided, as the following option service-a, to the home-network user 14. The provider 11 makes a bill in return for the service periodically or each time of providing update information.

Option Service-a: service for regularly updating the network security system 17.

The network-security managing service request in the step S27 has the following option services b to f to be provided besides the option service-a. Billing is possible in return for enjoying each option service.

Option Service-b: service of security checking for virus, security hole or the like, after providing the initial Internet-connection service or regularly updating the network security system.

Option service-c: service of regularly sending security information or security-update related information for the user to carry out with security and easiness.

Option service-d: service of adjusting for proxy the network parameter, in the best-effort connection service having connection speed variable depending upon the network parameter on the terminal.

Option service-e: service that, in the event of a network system failure due to a new or unknown security hole or virus, the failure is notified through the use of communication means of free-of-dialing or the like and repaired for proxy for a user.

Option service-f: service for the user to take a lecture commentary on network security, e.g. making a comment on network security on-line so that the user can enjoy the option service.

As described above, the present invention provides a personal network security service that a provider architects a connection environment to the Internet and a security system over a home server or Web terminal connected to the Internet, so that the initial fee can be billed in return therefor, and in addition to the fee the regular billing in return for regularly updating the system also can be billed. Furthermore, prepared are options that the user can receive security information regularly and the user can enjoy the option service.

Therefore, because the business entity, e.g. provider, architects and maintains for proxy the network security system and provides various services, the individual is relieved of risk and labor in using the Internet and hence provided with a secure and comfort Internet connection environment.

What is claimed is:

1. A network system comprising:
an Internet connecting section for architecting a connection environment to the Internet on a home network system having a home server and a plurality of Web terminals, and
a network security managing section for architecting a network security system to the home server;
the network security system being architected by a provider.

2. A network system according to claim 1, wherein the plurality of Web terminals is any selected from a personal computer, a television receiver and a home electronic appliance.

3. A network system according to claim 1, wherein the network security system includes at least a firewall and anti-virus software.

4. A network system according to claim 1, wherein the provider has the network security managing section, the network security managing section being to update at least one of the firewall and the anti-virus software.

5. A network system according to claim 4, wherein network security managing section is to provide an optional service for security check.

6. A network system according to claim 4, wherein network security managing section is to provide information for updating the firewall or anti-virus software to the network security system.

7. A network system according to claim 1, wherein the provider is further to provide for proxy, an optional service for adjusting, a network parameter of a best-effort connecting service that connection speed varies depending upon a network parameter on the Web terminal.

8. A network system according to claim 1, wherein the provider is further to provide an optional service for restoring, for proxy, from a failure in the event of a failure on the network system caused due to a new or unknown security hole or virus.

9. A network system according to claim 1, wherein the provider is further to provide an optional service for a user to take a commentary lecture on network security.

10. A network system according to claim 1, wherein the provider is to make a bill in return for architecting the network security system.

11. A network system according to claim 5, wherein the provider is to make a bill in return for the optional service of security check.

12. A network system according to claim 6, wherein the provider is to make a bill in return for providing information for updating a firewall and anti-virus software to the network security system.

13. A network system according to claim 7, wherein the provider is to make a bill in return for the optional service of network parameter adjustment for proxy.

14. A network system according to claim 8, wherein the provider is to make a bill in return for the optional service of restoring, for proxy, from a failure.

15. A network system according to claim 9, wherein the provider is to make a bill in return for the optional service of taking a commentary lecture.

16. A network system comprising:
an Internet connecting section for architecting a connection environment of a Web terminal to the Internet, and
a network security managing section for architecting a network security system to the Web terminal connected to the Internet;
the network security system being architected by a provider.

17. A network system according to claim 16, wherein the Web terminal is any selected from a personal computer, a television receiver and a home electronic appliance.

18. A network system according to claim 16, wherein the network security system includes at least a firewall and anti-virus software.

19. A network system according to claim 16, wherein the provider has the network security managing section, the network security managing section being to updating at least one of the firewall and the anti-virus software.

20. A network system according to claim 19, wherein network security managing section is to provide an optional service for security check.

21. A network system according to claim 19, wherein network security managing section is to provide information for updating the firewall or anti-virus software to the network security system.

22. A network system according to claim 16, wherein the provider is further to provide an optional service for adjusting, for proxy, a network parameter of a best-effort connecting service that connection speed varies depending upon a network parameter on the Web terminal.

23. A network system according to claim 16, wherein the provider is further to provide an optional service for restoring, for proxy, from a failure in the event of a failure on the network system caused due to a new or unknown security hole and virus.

24. A network system according to claim 16, wherein the provider is further to provide an optional service for a user to take a commentary lecture on network security.

25. A network system according to claim 16, wherein the provider is to make a bill in return for architecting the network security system.

26. A network system according to claim 20, wherein the provider is to make a bill in return for the optional service of security check.

27. A network system according to claim 21, wherein the provider is to make a bill in return for providing information for updating a firewall and anti-virus software to the network security system.

28. A network system according to claim 22, wherein the provider is to make a bill in return for the optional service of network parameter adjustment for proxy.

29. A network system according to claim 23, wherein the provider is to make a bill in return for the optional service of restoring, for proxy, from a failure.

30. A network system according to claim 24, wherein the provider is to make a bill in return for the optional service of taking a commentary lecture.
